(19) United States
(12) Patent Application Publication
(10) Pub. No.: US 2014/0172465 A1
(43) Pub. Date: Jun. 19, 2014

(54) System and Method For Dynamically Evaluating an Insurance Program of an Entity

(71) Applicant: MARSH USA INC., New York, NY (US)

(72) Inventor: Claude Yoder, Newtown, CT (US)

(73) Assignee: Marsh USA Inc., New York, NY (US)

(21) Appl. No.: 13/713,725

(22) Filed: Dec. 13, 2012

(51) Int. Cl. G06Q 40/08

(52) U.S. Cl. CPC G06Q 40/08
USPC 705/4

(57) ABSTRACT

Described is a system having a system server and a user device. The system server as part of the system and individually stores a database of insurance related information for each of a plurality of entities and further includes tool algorithms that perform analysis of the insurance related information to generate insurance related analytical information for each of the entities. The user device as part of the system and individually executes a tool application that includes a plurality of display screens, wherein to display each display screen the user device sends a selection of a subset of the insurance related information and insurance related analytical information corresponding to each display screen to the system server and receives the corresponding subset of the insurance related information and insurance related analytical information from the system server and displays the corresponding display screen via the tool application.

### BACKGROUND

Businesses and other entities typically carry a wide range of insurance policies to insure against risks to the business. These policies include, for example, property and casualty insurance, workers compensation insurance, director & officers insurance, etc. There are many analytical tools that allow a business to view various statistics concerning their insurance programs. However, viewing the results of these different analytical tools is cumbersome and time consuming. The output of the analytical tools is typically a spreadsheet based view that is difficult to read and the different analytical tools provide multiple outputs that cannot be effectively compared. Moreover, these analytical tools do not allow a user to easily generate alternate insurance programs or even make small changes to the current program in order to view how these changes will affect the overall insurance program. More typically, potential insurance programs are shared with corporations using “static” paper based presentations, with no ability to change data dynamically, in real-time.

### SUMMARY

A system having a system server that stores a database of insurance related information for each of a plurality of entities and further includes tool algorithms that perform analysis of the insurance related information to generate insurance related analytical information for each of the entities and a user device executing a tool application that includes a plurality of display screens, wherein to display each display screen the user device sends a selection of a subset of the insurance related information and insurance related analytical information corresponding to each display screen to the system server and receives the corresponding subset of the insurance related information and insurance related analytical information from the system server and displays the corresponding display screen via the tool application.

A device having a processor and a memory including a set of instructions. Executing the instructions cause the processor to execute a tool application that includes a plurality of display screens, wherein each of the display screens displays one of insurance related information for an insurance program of an entity and insurance related analytical information for the insurance program of an entity, send a request corresponding to one of the display screens to a system server that stores the insurance related information and insurance related analytical information, wherein the request includes an identification of the one of insurance related information and insurance related analytical information corresponding to the one of the display screens, receive a response to the request including the one of insurance related information and insurance related analytical information corresponding to the one of the display screens, format the one of insurance related information and insurance related analytical information corresponding to the one of the display screens and display the one of insurance related information and insurance related analytical information corresponding to the one of the display screens.

A system server having a processor and a memory including insurance related information for an insurance program of an entity, a database of product line information for each of a plurality of insurance companies and a set of instructions. Executing the instructions cause the processor to generate insurance related analytical information for the insurance program of the entity based on a set of tool algorithms, receive a request including an identification of one of insurance related information, the insurance related analytical information and one of the product line information and send a response to the request that includes the one of insurance related information, the insurance related analytical information and one of the product line information.

### BRIEF DESCRIPTION OF THE DRAWINGS

FIG. 1 shows an exemplary system for implementing the TCOR tool.

FIG. 2 shows a summary screen of an exemplary scenario using a TCOR tool for a business according to an exemplary embodiment.

FIG. 3 shows an updated summary screen where the contribution of two risk factors have each been reduced using the TCOR tool.

FIG. 4 shows a drill-down screen that is displayed by the TCOR tool when the program optimization tab is selected from the summary screen of FIG. 2.

FIG. 5 shows a further drill-down screen that is displayed by the TCOR tool when the program optimization tab is selected from the summary screen of FIG. 2.

FIG. 6 shows a drill-down screen that is displayed by the TCOR tool when the geospatial risk tab is selected from the summary screen of FIG. 2.

FIG. 7 shows a drill-down screen that is displayed by the TCOR tool when the benchmarking tab is selected from the summary screen of FIG. 2.

FIG. 8 shows a further drill-down screen that is displayed by the TCOR tool when the benchmarking tab is selected from the summary screen of FIG. 2.

FIG. 9 shows a drill-down screen that is displayed by the TCOR tool when the unique products tab is selected from the summary screen of FIG. 2.

FIG. 10 shows a drill-down screen that is displayed by the TCOR tool when the dynamic risk maps tab is selected from the summary screen of FIG. 2.

### DETAILED DESCRIPTION

The exemplary embodiments may be further understood with reference to the following description and the appended drawings, wherein like elements are referred to with the same reference numerals. The exemplary embodiments describe methods and systems for dynamically evaluating and dynamically displaying the results of the evaluation of the risk financing of an entity. The evaluation and displaying of the results includes the current insurance program of the entity, multiple alternative programs for the entity and comparison to other peer entities. In addition, the evaluation and results display may also include analysis and depictions of non-insurable risk issues. Throughout this description, the term “business” or the generic term “entity” will be used to describe the individual or organization for which the insurance program will be evaluated. It should be understood that the insurance program is not limited to businesses, but may be any buyer of insurance policies, which in addition to businesses, may include individuals, non-profit organizations, schools, government entities, etc.

The total cost of risk (“TCOR”) is the cost of managing risks and incurring losses for a business. The TCOR is the sum of all aspects of the business's operations that relate to risk. There are numerous aspects or risk factors of business operations that contribute to the TCOR. The exemplary embodiments will focus on risk factors such as losses, premiums, claims, collateral and capital charges. Describing the exemplary embodiments with respect to the above listed risk factors is only for illustrative purposes, as those skilled in the art will understand that other aspects of business operations may also contribute to the TCOR. These other risk factors may also be considered when calculating the TCOR in accordance with the exemplary embodiments using the same principles as described for the listed risk factors.

Obviously, the goal of every business is to reduce their TCOR. However, as will be demonstrated below, since each of these risk factors contribute to the TCOR and there are interactions between different aspects, it is not an easy task to merely reduce the cost of one of the risk factors to lower the TCOR. A business will desire to have many options to reduce their TCOR and see how each of these options affects various costs and operations. The exemplary embodiments provide a TCOR tool that allows a business to dynamically change scenarios and determine how the changing scenarios affect the TCOR and other factors.

In the below exemplary embodiments, the user of the TCOR tool will be considered to be a third party user such as a broker or consultant that is presenting different insurance program scenarios to the business. As will be described in greater detail below, there is a multitude of information stored by the TCOR tool that relates to the operations of multiple businesses. Thus, it is much more likely that a third party that interacts with multiple businesses such as a broker or consultant can gather the necessary information from multiple businesses that is used for the TCOR tool. However, it is not necessary that the user of the TCOR tool be a third party user, the business itself may have access to the TCOR tool (whether or not it is capable of gathering all the necessary information to support the TCOR tool) such that a business user may develop various scenarios and execute the TCOR tool to determine the effects of these scenarios on the business's TCOR.

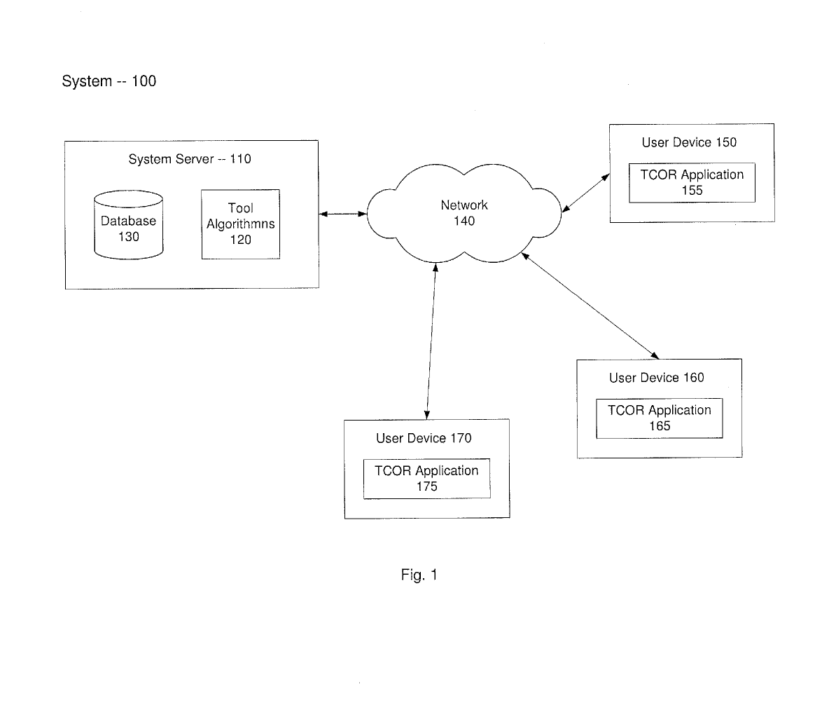

FIG. 1 shows an exemplary system 100 for implementing the TCOR tool. The system 100 includes a system server 110 that executes tool algorithms 120 and a database 130. The database 130 is populated with information concerning the business such as the costs and other information (e.g., policy information, line of business information, geographic information, and loss data) associated with the various risk factors described above. The information stored in the database 130 may be referred to as “insurance related information” which includes any of the information that is required to accomplish the functionalities described below. Thus, the “insurance related information” may include the information described previously, but also other types of information such as risk and risk finance related information. The database 130 also includes similar information for other businesses so that various comparisons may be made between the business of interest and other businesses or groups of businesses. Thus, the data for the various businesses is standardized such that the same type of operations may be carried out on all the data.

The tool algorithms 120 are the various formulas, dependencies and relationships that are used to calculate the values and information that are displayed for the different scenarios. The tool algorithms 120 operate on the data in the database 130 based on scenario information that is received from user devices 150-170. Thus, the tool algorithms are used to generate insurance related analytical information. Similar to the insurance related information described above, the insurance related analytical information includes information related to insurance and also other types of information such as risk and risk finance related information.

In this exemplary embodiment, the system server 110 is considered to be at a central location (e.g., an office of the broker or consultant). The system server 110 has access to a network 140 such as a company network, the Internet, etc. by which the system server 110 can send data to and receive data from the user devices 150-170 via conventional hardware and software known to those of skill in the art. The system server 110 being at a central location and having the database 130 and tool algorithms 120 residing on a single system server 110 is only exemplary. With network access, the system server 110 may reside anywhere and the database 130 and tool algorithms 120 (or subsets of either) may reside on separate hardware devices that have mutual access. For example, as will be described in greater detail below, the database 130 may store insurance policy information for a line of business, but it may also store videos offering a broker's perspective of the product line. These different types of information may be stored in different databases on the same or different network devices. However, these different databases are still considered to be the single database 130. It may also store a library of updateable forms, emerging issue presentations, white papers, etc.

Each user device 150-170 may access the system server 110 via network 140 to present the various scenarios and their effects on a business's TCOR. In one example, each user device 150-170 may have a TCOR application 155-175, respectively, installed on a device such as an iPad®, a tablet computer, a laptop computer or any other device that is conducive to display the results of the TCOR tool to the business. Various exemplary displays of the TCOR tool will be described in greater detail below. In general, a user operating user device 150 may be at a meeting place with representatives of a business. Throughout the remainder of this description, these representatives will be termed the business viewers. The user device 150 may pull information from the system server 110 to display, via the TCOR tool application 155, the current TCOR of the business. The user may then configure various scenarios for the business using the TCOR application 155. The user device 150 sends these scenarios to the system server 110 via the network 140. The system server 110 will then determine an updated TCOR and other information using the scenario received from the user device 150 and the tool algorithms 120 and information in the database 130. This updated TCOR along with supporting information will be sent back to the user device 150 to display the results to the business viewers via the TCOR application 155.

This interaction between the user device 150 and the system server 110 allows the user to run through any number of scenarios that can be dynamically updated because the system 100 leverages the advantages of the fast processing times and large data handling capabilities of the hardware used by the system server 110 and the portability and viewing capabilities of today's tablet computers. It should be noted that the use of three user devices 150-170 is only exemplary and that many more users may be simultaneously connected to the system server 110 in order to run the TCOR tool. Also, while the tool algorithms 120 are shown to be exclusively on the system server 110, it is possible to distribute some of the tool algorithms 120 to the user device.

Throughout the remainder of this description it will be assumed that the user devices 150-170 executing the TCOR application 155-175 are tablet computers such as an iPad®. Those skilled in the art are familiar with the operation of such devices and will understand when this description refers to the functionalities associated with the touch screens that these devices include such as tapping, clicking, scaling, etc. However, as described above other computing devices such as laptop computers that do not include touch screens may also be implemented as the user devices 150-170. Thus, the functionalities corresponding to the touch screen functionality may also be implemented by the TCOR application 155-175.

The remainder of this description will describe exemplary operations and display screens of the TCOR application 155-175 as executed by the user devices 150-170. However, as described above, the information that is generated to create the various displays on the user devices 150-170 may be generated by the system server 110 and sent to the user devices 150-170 for display. In addition, the exemplary displays described below normally show a single alternative scenario or program or are described with reference to a single line of business. Those skilled in the art will understand that the TCOR tool may include the analysis of many different scenarios and/or lines of business and the results of these many different scenarios and/or lines of business may be displayed on different displays of the TCOR application 155-175.

The exemplary operations and display screens of the TCOR application 155-175 will be described based on the following typical situation that was briefly described above. A representative of an insurance broker will be considered to be the user and have the user device 150 executing TCOR application 155. This user will be meeting with representatives of a business (the “business viewers”) to show them the current state of their insurance program and potential alternative programs or scenarios. The user will do this by creating alternative programs and showing the business viewers the exemplary displays described below. While this is a typical situation, it is not the only situation of use for the TCOR tool and alternative situations will readily present themselves to those skilled in the art.

As the exemplary displays of the TCOR application 155 are described, it should become apparent that the TCOR application 155 provides the user and the business viewers with information in an easy to view and understandable format. This understandable format provides numerous benefits for the business viewers including allowing them to understand how the various risk factors contribute to the business's TCOR, understand those risk factors that present the greatest risks and opportunities for the business, understand how alternative programs will affect the business's TCOR and benchmark the business against its peer businesses. In addition, the TCOR tool allows the user, with input from the business viewers, to create new or updated alternative programs and provide the results of the new or updated alternative programs in a dynamic manner in a matter of seconds.

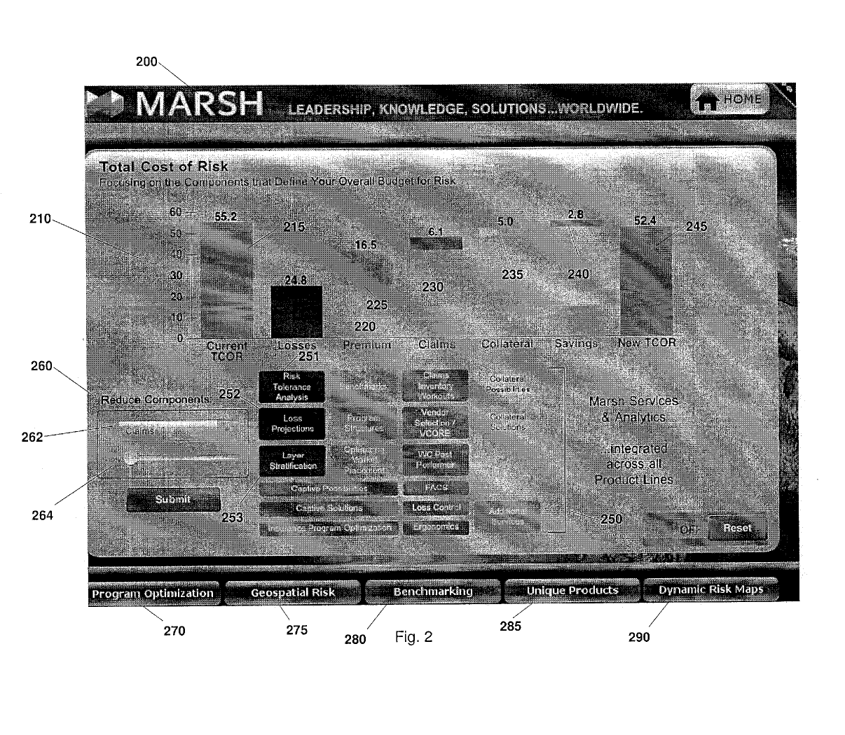

FIG. 2 shows a front page or home page summary screen 200 of an exemplary scenario using a TCOR tool for a business. The summary screen 200 shows a bar graph 210 in the upper portion of the screen that shows the current TCOR 215 having a value of 55.2. In this example, the values are actual dollar ($) values, but the TCOR value may also be presented in other manners such as a scaled value. As described above, the database 130 includes the information that allows the tool algorithms 120 to calculate the current TCOR for the business. This information is sent to the user device 150 for population within this summary screen 200 of the TCOR application 155. The TCOR tool also allows the user to see how the different areas of cost/risk interrelate, e.g. by changing the retained loss projections, the estimate of cost of collateral will change automatically.

The bar graph 210 also shows the contribution of different risk factors for a first alternative program. These risk factors may include losses 220 (value of 24.8), premiums 225 (value of 16.5), claims 230 (value of 6.1), collateral 235 (value of 5.0) and capital charges. As described above, these values 220-235 are for a particular scenario that is different from the current situation of the business. As will be described in greater detail below, the various scenarios are selected and/or created by making changes to the sections of the tool, e.g. changing the program optimization section to affect a change to a cost bucket or changing a cost directly on one of the pages. This new scenario results in a new TCOR 245 having a value of 52.4 that is a savings 240 of 2.8 over the current TCOR 215 of 55.2. Thus, the bar graph 210 of the summary screen 200 allows a business viewer to quickly see the results on the TCOR of the particular alternative scenario that has been selected.

The summary screen 200 also includes buttons 250 that show the various analyses and calculations that have been carried out to result in the contributions of each of the risk factors. The selection of one of the buttons allows the user to see the corresponding analytics. FIG. 2 is a gray scale drawing and, as such, does not show the various colors that are used to display the TCOR contributions of the risk factors. However, it may be considered that the bar graph 210 displays each of the risk factors 220-235 in different colors, e.g., losses 220 in purple, premium 16.5 in light blue, etc. The buttons 250 that correspond to the analyses performed to calculate the contribution of the risk factor losses 220 to the new TCOR 245 may be colored in the same manner as the bar graph losses 220, e.g., the risk tolerance analysis button 251, the loss projection button 252 and the layer stratification button 253 may be colored purple to correspond to the losses 220. The other buttons may be similarly colored.

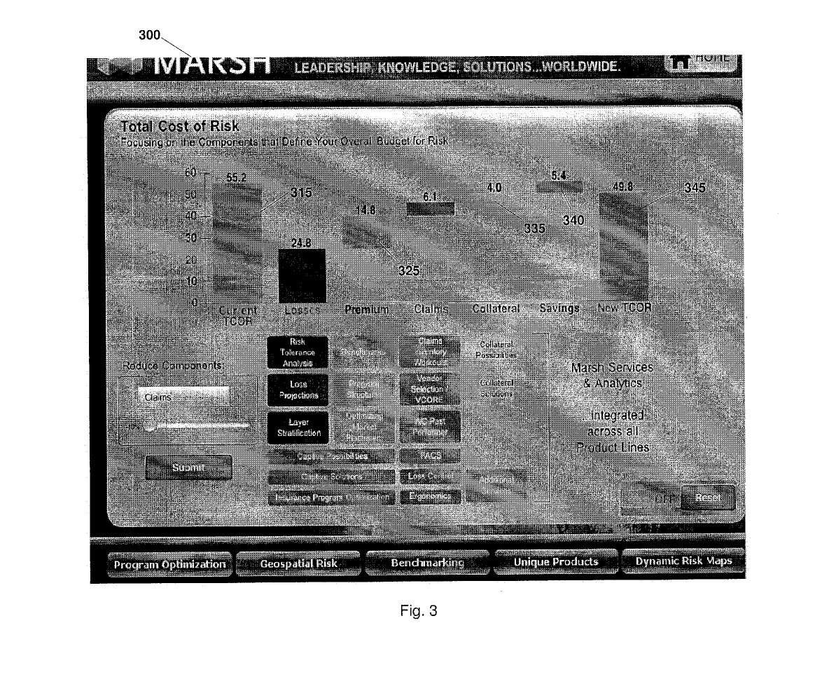

The summary screen 200 also includes a reduce components area 260 that allows a user to reduce one or more of the various risk factors by a specified percentage. The reduce components area allows a user via the dropdown menu 262 to select one of the risk factors 220-235 and reduce the cost of these factors via the scroll bar 264 by a specified amount (e.g., 10%, 20%, etc.). FIG. 3 shows an updated summary screen 300 where the contribution of the risk factors premium 325 and collateral 335 have each been reduced by 10% to values of 14.8 and 4.0, respectively. In this case, the new TCOR 345 is shown having a value of 49.8 that is a savings 340 of 5.4 over the current TCOR 315 of 55.2. Thus, the reduce components area 260 allows the user to reduce the various risk factors 220-235 to show the effects on the new TCOR 245.

Finally, the summary screen 200 also includes a series of tabs 270-290 at the bottom of the screen. These tabs 270-290 may be used to drill-down to further screens to provide more detailed information on the current program and alternative programs and their effects on the TCOR. Each of these drill-down screens and functionalities will be described in greater detail below.

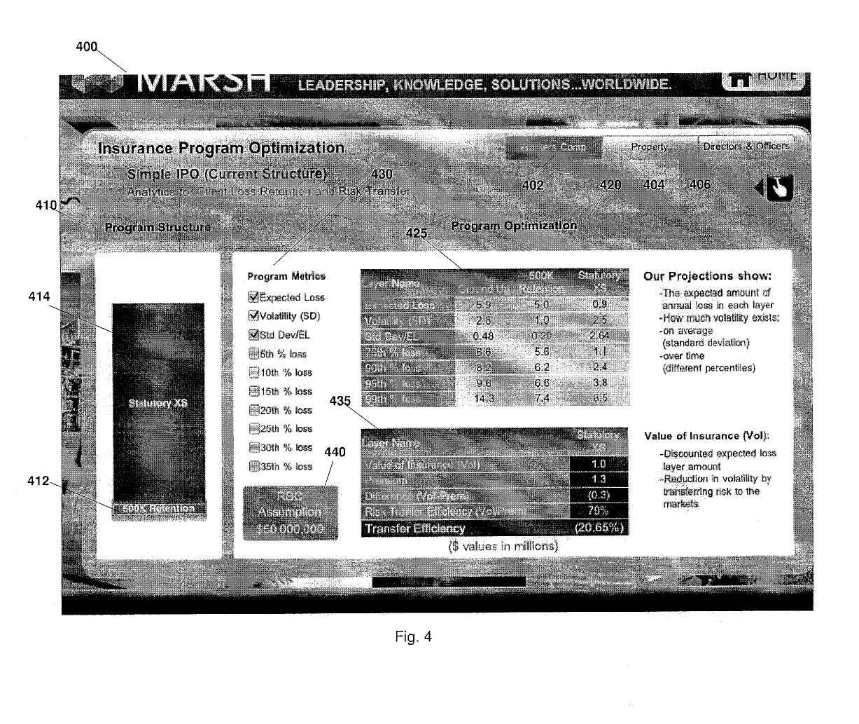

FIG. 4 shows a drill-down screen 400 that is displayed by the TCOR application 155 when the program optimization tab 270 is selected from the summary screen 200. As stated on the drill-down screen 400, this screen presents insurance program optimization information for the business based on the information for the business that is stored in the database 130. This first drill-down screen 400 shows the information for the current structure of the program. As will be described in greater detail below, subsequent drill-down screens show alternative programs, e.g., different scenarios for program optimization. Thus, this drill-down screen 400 provides the business viewers with an easy to view format of detailed information regarding their current program structure.

As shown in the upper right portion of the screen 400, there are three buttons, a workers comp(ensation) button 402, a property button 404 and a directors & officers button 406. Thus, this exemplary business has three lines of insurance that may be analyzed. In this example, the workers comp button 402 has been selected and the analytics for the workers compensation line of insurance are displayed. The particular analytics that are displayed on this screen 400 are client loss retention and risk transfer analytics for the workers comp line of insurance. Those skilled in the art will understand that there may be any number of buttons related to the lines of insurance for which the particular business has policies. In addition, the particular types of analytics may be different based on the line of insurance that is being analyzed. In addition, the TCOR tool also provides calculations for cross-line of insurance correlation to create a portfolio view of the TCOR.

The program structure portion 410 of the screen 400 shows a graphical representation of the structure of the workers comp program for this business as related to two separate layers, a client loss retention layer 412 and a risk transfer layer 414 also referred to as the statutory excess (XS) layer. Risk retention refers to the amount that the business is required to pay before the insurance policy will pay on claims. The risk transfer refers to the amount of risk that is transferred to the insurance company that has written the policy. In this particular case, the retention layer 412 amount is $500,000 and the statutory XS layer 414 is the amount over this value. In this example, the layer 414 amount is $10,000,000, which is not shown on the screen 400, but as described below is available via a pop-up window. While not shown in this figure, the TCOR application 155 allows the user to tap on these layers 412 and 414 of the program structure to receive additional information concerning the layer via a pop-up window. For example, by tapping on the retention layer 412, a pop-up window may appear that shows additional information concerning the layer 412 such as the layer size ($500,000) and various distribution statistics for the layer such as the mean and standard deviation. As described above, the database 130 stores policy and other information for the business and the tool algorithms 120 include the functionality to calculate various statistics for the business. In another example, the pop-up window may also show a risk loss curve for the layer 412. The same information may also be displayed for the statutory XS layer 414.

The program optimization portion 420 of the drill-down screen 400 shows information for the layers 412 and 414. The table 425 shows information such as the expected amount of annual loss in each layer, volatility on average which is based on standard deviation and selected percentile losses for the ground up layer (both layers 412 and 414 combined), the retention layer 412 and the statutory XS layer 414. As shown by selection menu 430, the user may modify the information shown in table 425 by checking and un-checking the boxes on the selection menu 430 based on the desire of the business viewers to see different information. As the boxes of the selection menu 430 are checked and unchecked, the table 425 is dynamically updated so that the business viewers may immediately view the desired information.

The table 435 shows information for the statutory XS layer 414 related to the value of insurance (VoI), which is the discounted expected loss layer amount. This further includes the premium and the difference between the value and the premium (VoI−premium). Additional calculated values are related to a reduction on volatility by transferring risk to the markets and include the risk transfer efficiency (VoI/premium) and the transfer efficiency. Again, those skilled in the art will understand that the program optimization values calculated and displayed on the drill-down screen 400 are only exemplary and other optimization values may be calculated and displayed.

The program optimization portion 420 also includes the risk bearing capacity (RBC) assumption box 440. The RBC is a measure of the capital available of the business to absorb risk. In this example, the RBC assumption is $50,000,000 and the values presented in the tables 425 and 435 are based on this RBC assumption value. However, the user may tap on the RBC assumption box 440 and change the value of the RBC assumption. This change of the RBC assumption value will result in changes to the values that are calculated in the tables 425 and 435. As described previously, the user will change the RBC assumption value via the box 440 of the TCOR application 155. The user device 150 will send the data related to the changed RBC assumption via the network 140 to the system server 110. The tool algorithms 120 will run the analytics on the data in the database 130 using the new RBC assumption value and generate the new statistics for the business's insurance program. The new statistics will be forwarded to the user device 150, so the TCOR application may populate the tables 425 and 435 with the new data. This process occurs in the matter of a few seconds and is essentially transparent to the business viewers such that it appears that the application 155 is processing the request and instantaneously showing the results of the request. The process described above to implement changes and display these changes is the same process that is used for the other exemplary screens that are described herein. However, as also described above, there may be some algorithms that are local to the user device 150 that do not require a large amount of processing power such that the user device 150 may process change requests that impact these locally stored algorithms.

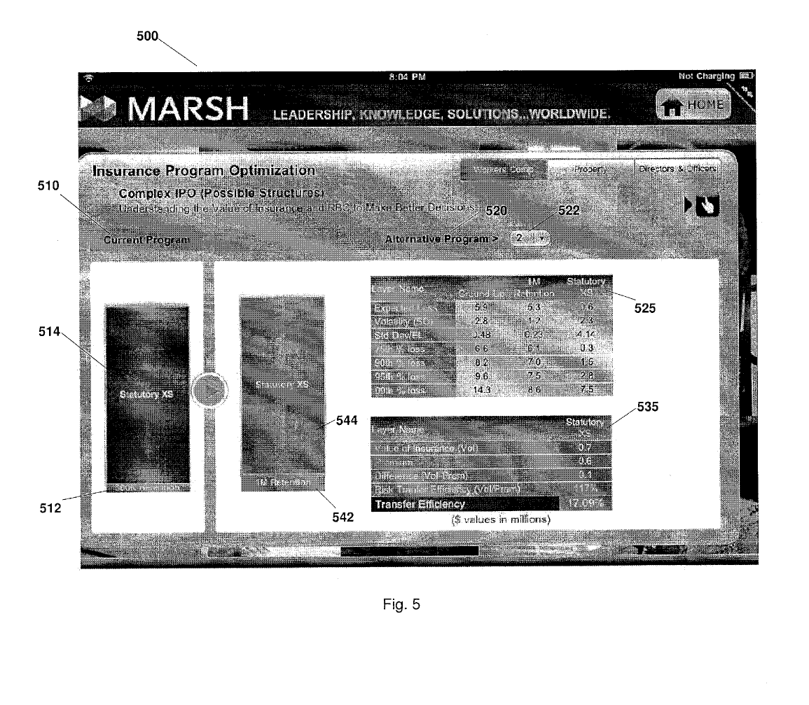

FIG. 5 shows a further drill-down screen 500 that is accessed from the program optimization tab 270 of the summary screen 200. The drill-down screen 500 is a comparison screen that shows a comparison between the current program 510 illustrated by the retention layer 512 and the statutory XS layer 514 and an alternative program 520. Typically, the user will first show the business viewers drill-down screen 400 and the data for the current program included thereon. The user will then swipe the screen of the user device 150 to show the business viewers the comparison drill-down screen 500. It should be apparent that the current program 510 and layers 512 and 514 are the same data as illustrated by screen 400 and current structure 410 and layers 412 and 414. The purpose of this drill-down screen 500 is to allow the users to view alternative program structures and see the impact on the portfolio by viewing the same parameters from the current program against the parameters for the selected scenario. In this case, the program optimization is based on the comparison of the VoI and the RBC to allow the business viewers to make more informed decisions regarding the program and/or changes to the program. This calculation is exemplary of a means to compare different program structures. Those skilled in the art will understand that users will be able to select essentially unlimited options and have real time results displayed for a selected insurance program structure.

Referring to the alternative program portion 520, a drop down menu is shown for the selection of the particular alternative program (e.g. scenario) that has been defined by the user. As described above, the user may dynamically define any number of scenarios by inputting insurance program structure characteristics such as retention, limit, layer, etc. The selection of different program structure characteristics may include pre-defined values such as +/−10%, 20%, etc. or may be free form fillable values by the user. The user may then save the different scenarios for use and comparison. The drop-down menu 522 may include any number of alternative programs that have been defined. In this example, the user has selected to view the comparison of the current program to alternative program 2. As shown in FIG. 4, the RBC assumption for the current program is $50,000,000 and the values are calculated for the alternative program using the same RBC. One of the changes for this alternative is the use of a $1,000,000 retention layer 542 as opposed to the $500,000 retention layer 512 for the current program. This may not be the only change that is made for this particular alternative program as there may be other changes to the program that are not visible on the screen. Similar to the pop-up windows described with respect to drill-down screen 400, a user may tap on any of the layers 512, 514, 542 or 544 on this drill-down screen 500 to display the statistics for the selected layer, e.g., layer size, distribution statistics (mode, mean, standard deviation, capital charges, etc.) and the risk loss curve. The tool allows the user and business viewers to dynamically view optimal and/or alternative insurance markets and solutions based on the user-selected criteria.

The alternative program portion 520 also includes tables 525 and 535 that show the corresponding parameters for the alternative program as the tables 425 and 435 for the current program. As described above, this allows the business viewers to see the differences between the current program and the selected alternative program to make more informed decisions as to the composition and parameters of the program. The user may dynamically display any number of these alternate programs to the business viewers.

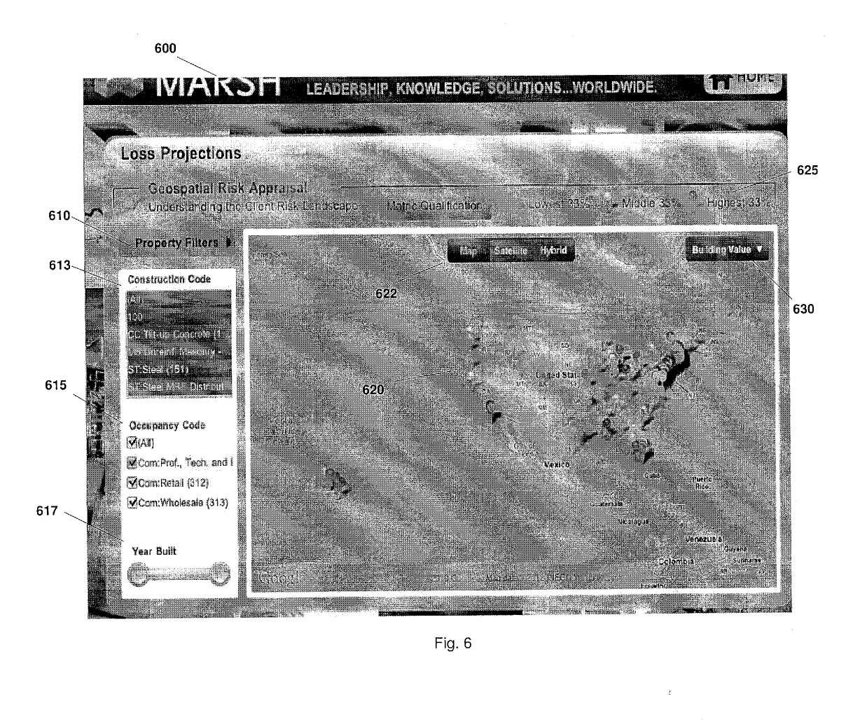

FIG. 6 shows a drill-down screen 600 that is displayed by the TCOR application 155 when the geospatial risk tab 275 is selected from the summary screen 200 of FIG. 2. The geospatial risk drill-down screen 600 allows the business viewers to see the client risk landscape based on loss projections on a geographic map. In this example, the business viewers are looking at the properties that the business is insuring in the United States. These properties are shown in a map view with each property being designated by a push-pin. The map and pins will be described in greater detail below. As described extensively above, the database 130 will include policy information for the business. Thus, the database 130 will include all the information to create the drill-down screen 600 and the accompanying pop-up windows that will be described in detail below. The user may select filters and metrics to narrow the focus of the geospatial display based on the specific information that the business viewers desire to see.

Referring to drill-down screen 600, the first set of filters is related to the types of properties, e.g., property filter 610. The first set of filters is a construction code filter 613 that allows the user to select the type of construction that the business viewers desire to see. In this example, the filters 613 include tilt-up concrete, unreinforced concrete, steel and steel MRF. However, those skilled in the art will understand that the filters 613 may correspond to all the types construction that the business has in its portfolio. The second set of filters 615 is related to the occupancy code of the property, e.g., commercial: professional, technical; commercial: retail; and commercial: wholesale. The final property filter is the year built filter 617 that allows the user to select the range of when the particular property was built. While not shown on drill-down screen 600, other filters may also be applied to the data. One example of a further set of filters is filters related to site filters. Examples of site filters include location type (e.g., distribution, general, home office, specific store, etc.), location tier, state, county, etc.

Once the user has selected the desired filters for the insured properties, the properties that match the filter criteria are displayed on the map 620 with each property being assigned a push-pin at its geographic location. As shown by buttons 622, the map may be displayed as a normal map (as shown in FIG. 6), a satellite view or a hybrid view. However, the map 620 with the push-pin property locations identified may also include further information for review by the business viewers. Specifically, as shown by the key 625, each push-pin may be color coded to group the selected properties according to a metric (described below) into groups. In this example, the groups include the lowest tier 33% (green), the middle tier 33% (yellow) and the highest tier 33% (red) of the selected metric. It should be understood that FIG. 6 is shown in gray scale, so the actual colors do not appear on the figure. Thus, each push-pin being color coded offers the business viewers additional information. For example, the business viewers may see that certain types of properties that are in the highest percentile of the metric are grouped in a specific geographic location.

The metric may be any metric that the business viewers may find interesting. In this example, the metric as shown by drop-down menu 630 is building value. Thus, the map 620 shows the properties with the highest 33% of values as red push-pins, the properties with the middle 33% of values as yellow push-pins and the properties with the lowest 33% of values as green push-pins. Other exemplary metrics that may be included on the drop-down menu 630 include content value, total value, client loss Average Annual Loss (AAL), gross AAL and ground-up AAL. Depending on the selected metric the color coded push-pin for each property may change as the percentiles into which the property falls may change depending on the metric.

In addition, the user may select a specific push-pin to present the business viewers with more specific details concerning the property associated with the push-pin as stored in the database 130. Examples of the specific data may include the name of the property, the address, the latitude and longitude of the location, the information related to the property filters such as occupancy codes and building types, the specific values for the metric identified above and also a photograph of the property.

Those skilled in the art will understand that the above description of the drill-down screen 600 was related to commercial property insurance. Different lines of insurance may have different geospatial aspects. Information shown can contain insurance program data from other sections of the application. This information will change dynamically on the property, geospatial section based on the user's selection. Those skilled in the art will understand that the above descriptions are examples of what can be shown.

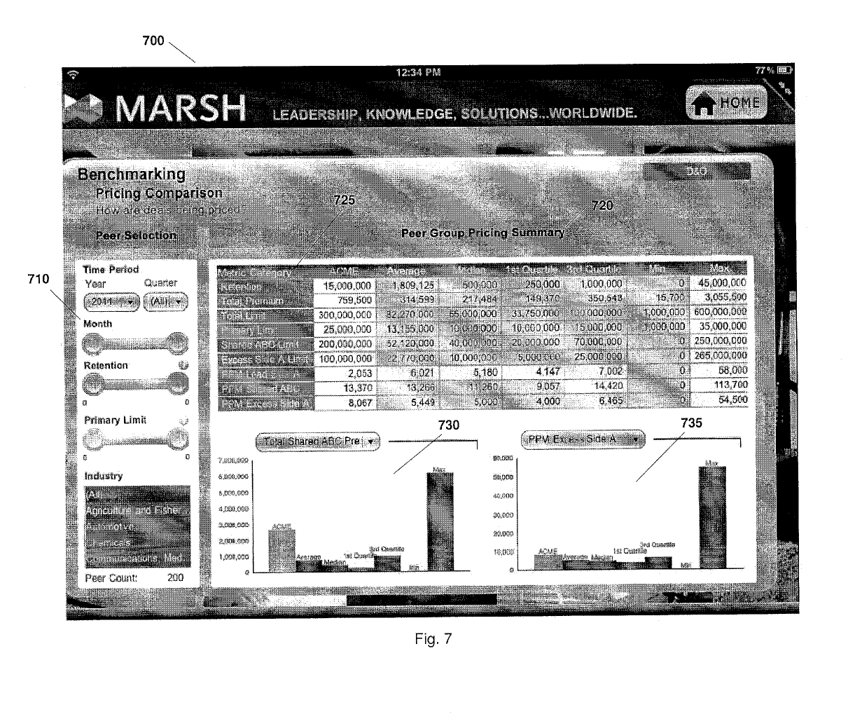

FIG. 7 shows a drill-down screen 700 that is displayed by the TCOR application 155 when the benchmarking tab 280 is selected from the summary screen 200 of FIG. 2. As described above, the database 130 also includes information for businesses other than the business with which the current viewers are associated. This allows the business viewers to view their programs against benchmarks for other peer businesses. In this particular example, the comparison is for pricing of bound policies in the directors & officers line of business for the business and the selected peer businesses. However, those skilled in the art will understand that other types of comparisons can also be made, for example, pricing for quoted policies, other lines of business, etc.

Initially, referring to peer selection portion 710 of drill-down screen 700, the user may select the types of businesses with which the business with which the current viewers are associated should be compared. The first selections are for a time period that may be year and a further selected quarter or a year and a selected time period within the year that does not correspond to quarters. The next selections are based on the retention values and the primary limit values. Other selections may be related to the industry or geographies of the businesses. The use of this particular data to identify peer businesses is only exemplary and those skilled in the art will understand that other parameters may be used to identify peer businesses. Based on these selections by the user, the drill-down screen 700 will show the number of peer businesses that are used for benchmarking purposes. In this example there are 200 peer businesses that match the selected parameters.

The peer group pricing summary portion 720 shows a table 725 that compares the business (labeled here as ACME) to the peer businesses that were selected using the above described selection criteria. The first column of the table 725 shows the metrics that were selected for comparison between the business and the peer businesses. Again, those skilled in the art will understand that other metrics may also be selected for comparison. The second column shows the values for the business while the remaining columns show statistics for the peer businesses. It should be noted that the peer businesses are not specifically identified by name (and information may be provided on an aggregate, and not individual, basis) because there may be confidentiality and competitive concerns if this type of data were displayed. As can be seen from table 725, the business viewers may compare their insurance program to that of its peers.

The drill-down screen 700 also shows two additional graphs 730 and 735 that may be used to show a graphical representation of the comparison metrics and statistics that are presented in the table 725. The two graphs 730 and 735 also allow two of these metrics to be presented for side-by-side comparison.

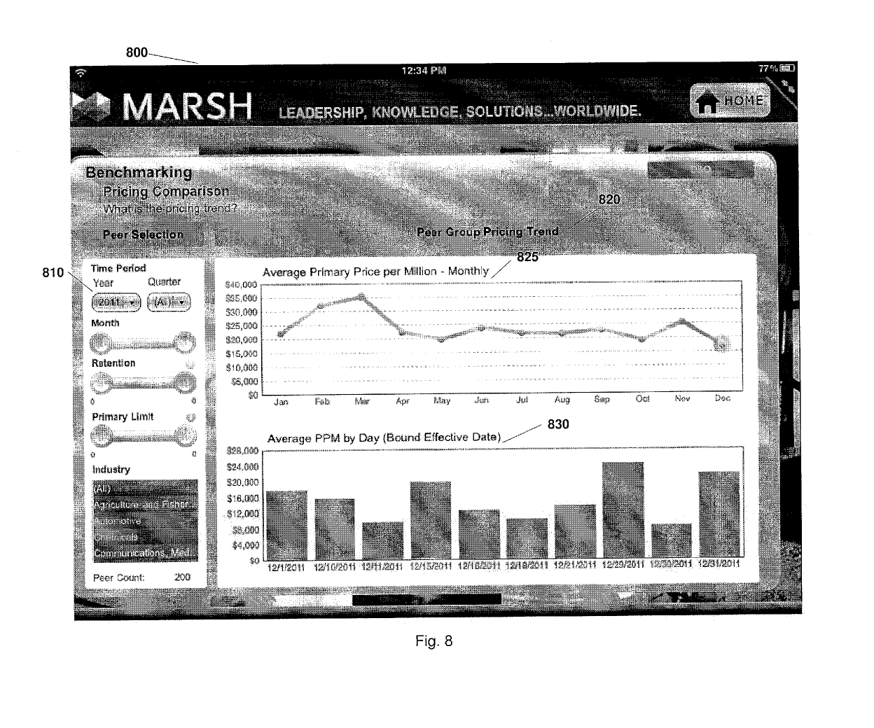

FIG. 8 shows a further drill-down screen 800 that is displayed by the TCOR application 155 when the benchmarking tab 280 is selected from the summary screen 200 of FIG. 2. This drill-down screen 800 may be used to display the pricing trend of bound director & officer policies for the selected group of peer businesses. The drill-down screen 800 includes the same peer selection portion 810 as drill-down screen 700. For normal comparisons, the user is likely to select the same peer group for the two drill-down screens so that the business viewers are seeing the same peer group for the two comparison screens 700 and 800. In fact, when switching between the drill-down screens 700 and 800, the peer group selection may stay the same and may change only if the user specifically makes different selections in the peer selection portions 710 and 810.

The peer group pricing trend portion 820 includes two graphs, an average primary price of bound policies on a monthly basis 825 and the average primary price by day 830. The months and days displayed on the graphs 825 and 830 may be selected by the user, for example, by tapping on a particular month on the graph 825, the graph 830 may be updated to show the relevant days for that particular month. In the example of FIG. 8, the user may have tapped on December in graph 825 so the relevant days of December are shown in graph 830.

The drill-down screens 700 and 800 may be used to show the business viewers how the business compares to its peers. The business viewers may use this information for any number of reasons such as to consider pricing decisions, consider retention decisions, etc.

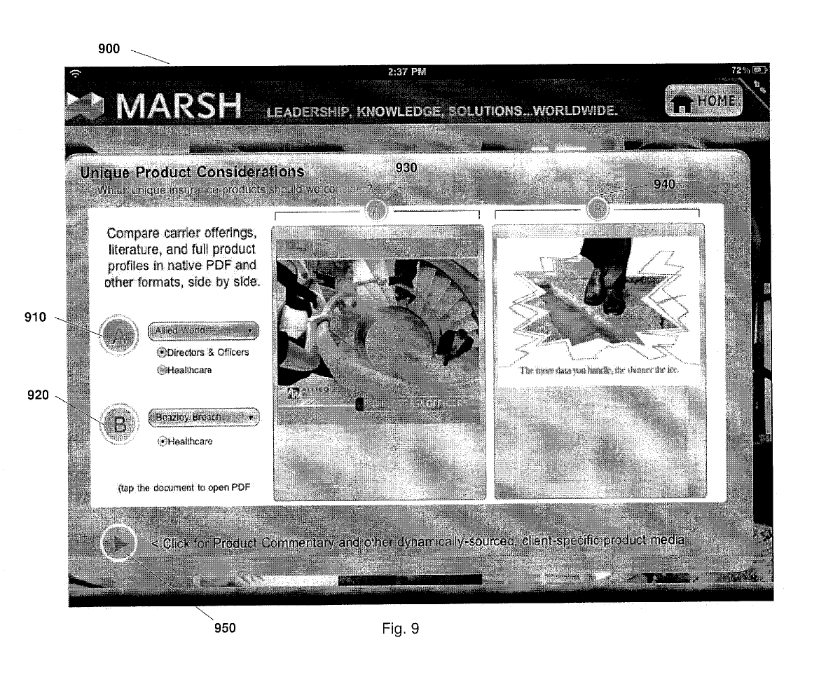

FIG. 9 shows a drill-down screen 900 that is displayed by the TCOR tool when the unique products tab 285 is selected from the summary screen 200 of FIG. 2. This drill-down screen 900 provides the business viewers with options and information on insurance product lines (lines of business) that are offered by insurance companies. The business viewers may use this information to consider whether the business should consider purchasing the product line and from what insurer. In a further example, if the business is already purchasing the same type of insurance product, the business viewers may compare the types of features that their current insurance company offers against the same types of policies offered by other insurance companies.

The user may select a first insurance company A 910 using the corresponding drop-down menu that includes a list of multiple insurance companies for which the database 130 includes data on the product lines. When the insurance company A 910 has been selected a further button menu will appear and show the product lines that the selected insurance company A 910 offers. The user may then select any one of the buttons to select the product line that the business viewers desire to see. In this example, insurance company A 910 has been selected to be Allied World and the line of business is directors & officers. When this selection has been made, information will appear for the insurance company and line of business in the area A 930 of the drill-down screen 900. The information will be described in greater detail below.

Similarly, the user may also select an insurance company B 920 and a line of business for that insurance company. In this example, the insurance company B is Beazley Beach and the line of business is healthcare. When that selection is made, information will appear for the insurance company and line of business in the area B 940 of the drill-down screen 900. It should be noted that it is normally expected, but not required, that the selection of lines of business for insurance companies A 910 and B 920 would be the same to allow for a side-by-side comparison of the products offered by the selected insurance companies. It is not a requirement that both insurance company A 910 and B 920 be selected. For example, it may be that the business viewers only desire to see a particular product line offering from a specific insurance company.

The information that is displayed in the areas A 930 and B 940 may be any type of information that the database 130 stores for the product offering for the selected insurance company. In this example, the areas A 930 and B 940 show a front cover of a brochure for each of the corresponding product offerings that is in PDF format. By clicking on the front cover, the TCOR application 155 opens a PDF viewer so that the business viewers may review the entirety of the brochures. The information is not limited to PDF brochures, but may be brochures or the like in any format (e.g., Word), may be Power Point or other presentations, may be text or XML data that lists information for the selected product line. Thus, by viewing this information, the business viewers may gather information concerning the product line offerings of insurance companies and comparisons thereof. The information may also include any relevant information for insurance companies beyond product offerings such as: emerging issues presentations, white papers, and industry specific topics.

The drill-down screen 900 also includes a play button 950. This play button will be active if the database 130 includes multimedia content related to the selected product line for the insurance companies A 910 or B 920. For example, a representative of the user (e.g., an employee of a broker) may have prepared a product commentary video concerning the selected product line. Selecting the play button 950 allows the business viewers to hear the broker's perspective of the selected product line. In another example, the insurance company A 910 may have a prepared multimedia presentation on the product line that may be displayed to the business viewers. It should be apparent that if the user is running the TCOR tool on a tablet computer having multimedia capabilities, the selection of the play button will seamlessly open a new multimedia application to show the video or multimedia presentation that is streamed from the system server 110 via network 140 to the user devices 150-170.

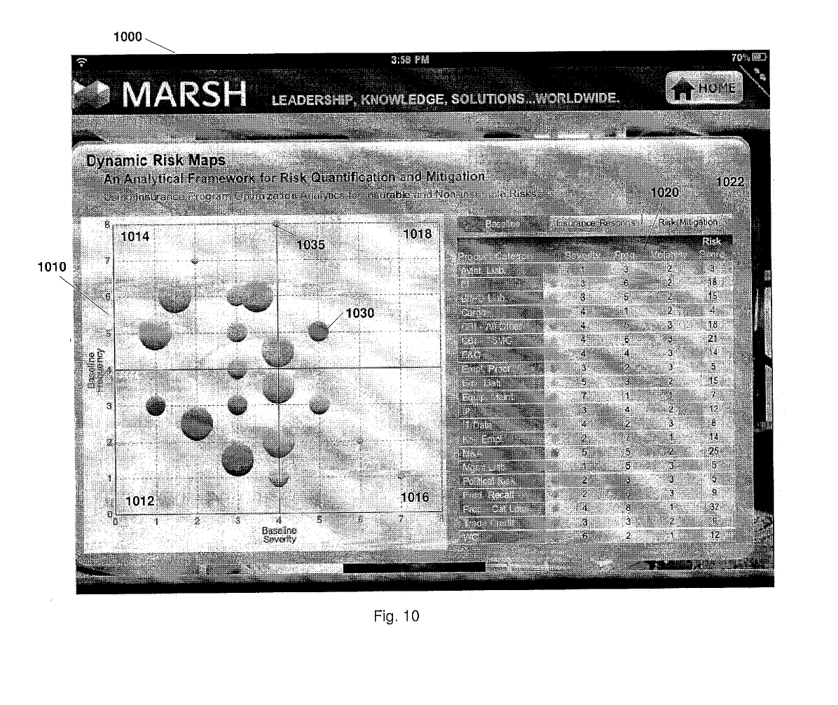

FIG. 10 shows a drill-down screen 1000 that is displayed by the TCOR application 155 when the dynamic risk maps tab 290 is selected from the summary screen 200 of FIG. 2. The dynamic risk map 1010 is an analytical framework for risk quantification and mitigation using insurance program optimization analytics for insurable and non-insurable risks. The dynamic risk map 1010 includes a series of colored circles placed on the map that are related to the severity of the risk, the frequency of the risk and the volatility of the risk. Again, FIG. 10 is displayed in gray scale, so the colors are not apparent in the figure, but will be explained in greater detail below. The circles are placed on the graph based on the frequency of the risk (y axis) and the severity of the risk (x axis). The size of each circle is based on the volatility of the risks. Each circle represents a specific line of business for the entity.

As described above for the information displayed on various screens throughout this description, the database 130 includes information concerning the entity and its lines of business. The tool algorithms 120, upon receiving a request for the dynamic risk map 1010 from a user, retrieve the information for the business and calculate the values needed to populate the dynamic risk map. In this example, the tool algorithms 120 calculate the severity, frequency and volatility of the risks for each of the lines of business for the business. The results of the calculations are a scaled value of 1-8 for the severity and frequency and a scaled value of 1-3 for the volatility. Since these scaled values are relative, those skilled in the art will understand that any common scale may be used, for example, the values could be scaled 1-100 instead of 1-8 and the axes of the dynamic risk map varied accordingly. The tool also provides the user the ability to dynamically change the risk issues shown and their frequency, severity and volatility metrics.

In this example, the risk map 1010 is broken into four quadrants 1012-1018. The first quadrant 1012 includes those risks that have a relatively low frequency of occurrence (scaled value of 0-4) and a relatively low severity upon occurrence (scaled value of 0-4). The second quadrant 1014 includes those risks that have a relatively high frequency of occurrence (scaled value of 4-8), but a relatively low severity upon occurrence (scaled value of 0-4). The third quadrant 1016 includes those risks that have a relatively low frequency of occurrence (scaled value of 0-4), but a relatively high severity upon occurrence (scaled value of 4-8). The fourth quadrant 1018 includes those risks that have a relatively high frequency of occurrence (scaled value of 4-8) and a relatively high severity upon occurrence (scaled value of 4-8). The placement of the circles within the quadrants 1012-1018 determines the color of the circle. For example, circles that are completely within the quadrant 1012 are colored green indicating that there is relatively low risk associated with these lines of business. Circles that are in the quadrants 1014 and 1016 or straddle these quadrants and quadrants 1012 and 1018 are colored yellow indicating that there is a moderate amount of risk associated with these lines of business. Circles that are completely within the quadrant 1018 are colored red indicating that there is a high amount of risk related to these lines of business.

Thus, a business viewer may look at the dynamic risk map 1010 and quickly assess the insurance program based on the coloring of the circle, the size of the circle and the placement within the quadrants 1012-1018. For example, it is fairly easy to tell that the M&A line of business that is represented by the circle 1030 is of concern because it is in the quadrant 1018, colored red and has a relatively high degree of volatility based on the size of the circle 1030. In contrast, the property catastrophic loss line of business that is represented by the circle 1035 is not of as great a concern because while it has a moderate level of severity and a high level of frequency, the volatility is relatively low. Thus, this will give the business viewers an idea of those lines of business that they desire to view in more detail to assess the program.

In this example, the displayed dynamic risk map 1010 is for the baseline risks as shown by the buttons 1022. However, other types of dynamic risk maps such as insurance response and risk mitigation may also be displayed to the business viewers. Referring to table 1020, some of the basic information that is used to populate the dynamic risk map 1010 is displayed. The first column of the table 1020 shows the product lines for the business. The second column shows the severity of the risks for each of the product lines based on the 1-8 scale for placement on the x-axis of the dynamic risk map 1010. The third column shows the frequency of the risks for each of the product lines based on the 1-8 scale for placement on the y-axis of the dynamic risk map 1010. The fourth column shows the volatility of the risk that dictates the size of the circle. The final column shows the risk score that is based on multiplying the severity by the frequency. For example, the cargo product line has a severity of 4 and a frequency of 1 resulting in a risk score of 4 (4*1). The risk score provides an indication to a viewer of how large a loss is associated with the risk.

The exemplary embodiments describe above include methods and systems for dynamically evaluating and dynamically displaying the results of the evaluation of an insurance program of a business. As described above, the display screens provide for the easy viewing and grouping of information related to the current program of the business, multiple alternative programs for the business and comparison to other peer insurance companies. The business viewers may use this information to understand their program and evaluate different changes to the program.

Those skilled in the art will understand that the above-described exemplary embodiments may be implemented in any suitable software or hardware configuration or combination thereof. In a further example, the exemplary embodiments of the systems and methods for evaluating a program of an business may be a program containing lines of code stored on a non-transitory computer readable storage medium that, when compiled, may be executed on a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

1. A system, comprising:
a system server that stores a database of insurance related information for an insurance program for each of a plurality of entities and further includes tool algorithms that perform analysis of the insurance related information to generate insurance related analytical information for the insurance program for each of the entities, wherein each of the insurance programs includes a plurality of insurance policies purchased by the entity; and
a user device executing a tool application that includes a plurality of display screens, wherein to display each display screen the user device sends a selection of a subset of the insurance related information and insurance related analytical information corresponding to each display screen to the system server and receives the corresponding subset of the insurance related information and insurance related analytical information from the system server and displays the corresponding display screen via the tool application,
wherein the tool application, via the corresponding display screen, receives a parameter input from a user, the parameter being a change to a portion of the insurance related information for current insurance policies in the insurance program of one of the entities being displayed on the corresponding display screen,
wherein the user device sends the parameter input to the system server which generates updated insurance related analytical information for the current insurance policies in the insurance program displayed on the corresponding display screen,
wherein the system server sends the updated insurance related analytical information to the user device which updates the corresponding display screen with the updated insurance related analytical information.

2. (canceled)

3. The system of claim 1, wherein the one of the display screens displays a comparison of the insurance related analytical information and the updated insurance related analytical information.

4. The system of claim 1, wherein one of the display screens of the tool application receives a filter input from a user, the user device sends the filter input to the system server and the system server filters the insurance related information based on the filter input and sends the filtered insurance related information to the user device which updates the one of the display screens based on the filter input.

5. The system of claim 1, wherein the insurance related information includes one of insurance policy information, loss information, premium information, claims information, collateral information, line of business information, retention information, risk bearing capacity information, risk tolerance, risk appetite, insurance limit information and non-insurable risk information.

6. The system of claim 1, wherein the insurance related analytical information includes a total cost of risk, a standard deviation for a layer of losses, percentiles for a layer of losses, a volatility for a layer of losses, a value of insurance for a layer of loss, a risk transfer efficiency for a layer of loss, a size of a layer of loss, distribution statistics for a layer of loss, and a risk loss curve for a layer of loss.

7. The system of claim 1, wherein the system server further stores a database of product line information for each of a plurality of insurance companies, the system server receives a request from the user device as to one of the insurance companies and a corresponding product line information for the one of the insurance companies and sends the product line information for the one of the insurance companies to the user device for display via the tool application.

8. The system of claim 7, wherein the product line information includes one of written material for a product line and a multimedia presentation for a product line.

9. The system of claim 1, wherein one of the display screens of the tool application receives an entity input from a user selecting one of the entities, the user device sends the entity input to the system server and the system server sends the insurance related information and insurance related analytical information for the selected entity to the user device which displays the insurance related information and the insurance related analytical information based on the entity input.

10. The system of claim 9, wherein the one of the display screens of the tool application further includes a peer input to select peer entities for the selected entity, the user device sends the peer input to the system server and the system server sends the insurance related information and insurance related analytical information for the peer entities to the user device which displays the insurance related information and the insurance related analytical information based on the peer input.

11. The system of claim 10, wherein the one of the display screens displays the insurance related information and insurance related analytical information for the peer entities and aggregated statistics for the peer entities.

12. The system of claim 1, wherein the user device is one of a tablet computer and a laptop computer.

13. A device, comprising:
a processor; and
a memory including a set of instructions, which when executed cause the processor to perform operations, comprising:
executing a tool application that includes a plurality of display screens, wherein each of the display screens displays one of insurance related information for an insurance program of an entity and insurance related analytical information for the insurance program of an entity, wherein the insurance program includes a plurality of insurance policies purchased by the entity;
sending a request corresponding to one of the display screens to a system server that stores the insurance related information and insurance related analytical information, wherein the request includes an identification of the one of insurance related information and insurance related analytical information corresponding to the one of the display screens;
receiving a response to the request including the one of insurance related information and insurance related analytical information corresponding to the one of the display screens;
formatting the one of insurance related information and insurance related analytical information corresponding to the one of the display screens;
displaying the one of insurance related information and insurance related analytical information corresponding to the one of the display screens;
receiving a parameter input from a user, the parameter being a change to a portion of the insurance related information for current insurance policies in the insurance program of the entity;
sending the parameter input to the system server, wherein the parameter input is used to generate updated insurance related analytical information for the current insurance policies in the insurance program that correspond to the one of the display screens;
receiving the updated insurance related analytical information corresponding to the one of the display screens; and
updating the one of the display screens to display the updated insurance related analytical information.

14. The device of claim 13, wherein the one of the display screens displays the one of the insurance related information and the insurance related analytical information in graphical format.

15. The device of claim 13, wherein the one of the display screens displays the one of the insurance related information and the insurance related analytical information in a map format.

16. The device of claim 13, wherein the one of the display screens includes color coded information that groups one of the insurance related information and insurance related analytical information based on corresponding values.

17. The device of claim 1, wherein the one of the display screens displays the insurance related analytical information in a risk map format.

18. (canceled)

19. The device of claim 18, wherein the one of the display screens displays a comparison of the insurance related analytical information and the updated insurance related analytical information.

20. The device of claim 13, wherein the insurance related information includes one of insurance policy information, loss information, premium information, claims information, collateral information, line of business information, retention information, risk bearing capacity information, insurance limit information and non-insurable risk information.

21. The device of claim 13, wherein the insurance related analytical information includes one of a total cost of risk, a standard deviation for a layer of losses, percentiles for a layer of losses, a volatility for a layer of losses, a value of insurance for a layer of loss, a risk transfer efficiency for a layer of loss, a size of a layer of loss, distribution statistics for a layer of loss, and a risk loss curve for a layer of loss.

22. The device of claim 13, wherein the operations further comprise:
sending a further request corresponding to the one of the display screens to a system server that further stores the insurance related information for insurance programs of other entities and insurance related analytical information for other entities, wherein the request includes an identification of the one of insurance related information and insurance related analytical information for the other entities corresponding to the one of the display screens;
receiving a further response to the further request including the one of insurance related information and insurance related analytical information for the other entities corresponding to the one of the display screens;
formatting the one of insurance related information and insurance related analytical information for the other entities corresponding to the one of the display screens; and
simultaneously displaying the one of insurance related information and insurance related analytical information and the one of the insurance related information and insurance related analytical information for the other entities corresponding to the one of the display screens.

23. The device of claim 13, wherein the user device is one of a tablet computer and a laptop computer.

24. A system server, comprising:
a processor; and
a memory including insurance related information for an insurance program of an entity, wherein the insurance program includes a plurality of insurance policies purchased by the entity, a database of product line information for each of a plurality of insurance companies and a set of instructions, which when executed cause the processor to perform operations, comprising:
generating insurance related analytical information for the insurance program of the entity based on a set of tool algorithms;
receiving a request including an identification of one of insurance related information, the insurance related analytical information and one of the product line information;
sending a response to the request that includes the one of insurance related information, the insurance related analytical information and one of the product line information
receiving a further request including a parameter input, the parameter being a change to a portion of the insurance related information for current insurance policies in the insurance program of the entity;
generating updated insurance related analytical information for the current insurance policies in the insurance program based on the parameter input; and
sending a further response including the updated insurance related analytical information for the current insurance policies in the insurance program.

25. (canceled)

26. The system server of claim 24, wherein the insurance related information includes one of insurance policy information, loss information, premium information, claims information, collateral information, line of business information, retention information, the use of a captive insurer, risk bearing capacity information, insurance limit information and non-insurable risk information.

27. The system server of claim 24, wherein the insurance related analytical information includes one of a total cost of risk, a standard deviation for a layer of losses, percentiles for a layer of losses, a volatility for a layer of losses, a value of insurance for a layer of loss, a risk transfer efficiency for a layer of loss, a size of a layer of loss, distribution statistics for a layer of loss, a capital charge and a risk loss curve for a layer of loss.
